(19) United States
(12) Patent Application Publication
(10) Pub. No.: US 2019/0108559 A1
(43) Pub. Date: Apr. 11, 2019

(54) EVALUATION-INFORMATION GENERATION SYSTEM AND VEHICLE-MOUNTED DEVICE

(71) Applicant: ALPINE ELECTRONICS, INC., Tokyo (JP)

(72) Inventor: Shuichi Suto, Iwaki-shi (JP)

(73) Assignee: ALPINE ELECTRONICS, INC., Tokyo (JP)

(21) Appl. No.: 16/141,248

(22) Filed: Sep. 25, 2018

(30) Foreign Application Priority Data
Oct. 11, 2017 (JP) 2017-197353

(51) Int. Cl. G06Q 30/02; G10L 15/18; G10L 15/22; G10L 25/72; G01C 21/36; G06F 17/30; B60R 11/02

(52) U.S. Cl. CPC G06Q 30/0282; G10L 15/1822; G10L 15/22; G10L 25/72; B60R 2011/0294; G06F 17/30241; B60R 11/0247; B60R 11/0258; G10L 2015/228; G01C 21/3679

(57) ABSTRACT

An evaluation-information generation system includes: a vehicle-mounted device and a server that generates evaluation information regarding a facility, based on information provided from the vehicle-mounted device. The vehicle-mounted device estimates a host-vehicle stop-off facility, collects in-vehicle conversation information over a certain period of time, associated with the estimated facility, determines whether the collected conversation information includes a reputation keyword expressing a facility reputation, and transmits, in a case where the reputation keyword is included, the collected conversation information and identification information regarding the estimated facility, to the server. The server generates, on the basis of the received conversation information and identification regarding the facility, evaluation information including a phrase expressing an evaluation of service or merchandise provided by the facility, to register the generated evaluation information into a database.

### RELATED APPLICATION

The present application claims priority to Japanese Patent Application Number 2017-197353, filed Oct. 11, 2017, the entirety of which is hereby incorporated by reference.

### BACKGROUND

### 1. Field of the Invention

The present invention relates to a facility-information generation system that generates evaluation information regarding a facility or the like. More particularly, the present invention relates to a method of generating evaluation information on the basis of in-vehicle voice conversation.

### 2. Description of the Related Art

WO 2015/059764A discloses a navigation system that conducts voice recognition on the conversation content of a user in a vehicle and automatically acquires, on the basis of a result of the recognition and positional information, evaluation information regarding the spot or the region, the navigation system being configured to add, in use, the evaluation information to map data to be displayed, to support the comfortable travel of the user. WO 2014/174640A discloses an evaluation information posting device that extracts a keyword regarding a facility and a keyword regarding evaluation from the conversation content of a user, determines a stop-off facility on the basis of positional information when a moving vehicle stops and the extracted keyword regarding a facility, and generates facility evaluation information on the basis of facility information regarding the stop-off facility and the extracted keyword regarding evaluation. Furthermore, J P 2011-179917A discloses an information recording device that, in a case where a moving vehicle is located within a certain range from a facility, conducts voice recognition on the conversation content of a passenger in the moving vehicle, determines, in a case where the conversation content includes a phrase indicating the facility and an adjective phrase for the facility, that the conversation content relates to the facility, records the facility in association with voice data of the conversation content, and presents, when the facility is retrieved, the associated voice data.

POI information (facility information) stored in a map database (DB) used in a navigation device includes facility genre information in addition to facility names and facility positional information. Thus, a genre that is a favorite of a user can be recommended in facility retrieval, but the reputation of merchandise carried in the facility or the reputation of service provided by the facility cannot be recommended.

It is considered that a social network service (SNS) is analyzed to use, for the recommendation, the reputation of the facility in association with the POI information, but it is unlikely that a sufficient amount of information for the recommendation is collected with only information posted on the SNS.

On the other hand, as disclosed in WO 2014/174640A and JP 2011-179917A, the conversation content of an in-vehicle passenger is subjected to text analysis to determine whether the topic relates to a target facility, so that evaluation information regarding the facility can be automatically generated. However, during conversation immediately after stopping off at a facility, for example, the name of the facility is often not included in the conversation or the conversation is often considerably simple. Thus, it is difficult to determine whether the topic relates to the target facility. FIG. 1 illustrates in-vehicle conversation immediately after a visit to a restaurant. The conversation includes no facility name, and thus it cannot be determined, only with conversation content, which facility is being evaluated. WO 2014/174640A and JP 2011-179917A each are based on the premise that conversation content includes a facility name, and thus are not intended for solving the problem.

### SUMMARY

An object of the present disclosure is to provide an evaluation-information generation system capable of learning individual preference from in-vehicle conversation content and extracting the reputation of a facility, simultaneously, to fulfill information to be used for recommendation, and a vehicle-mounted device.

Another object of the present disclosure is to provide an evaluation-information generation system capable of precisely automatically generating evaluation information regarding a facility even when conversation content includes no facility name, and a vehicle-mounted device.

An evaluation-information generation system according to an embodiment of the present invention includes: a vehicle-mounted device and a server configured to generate evaluation information, based on information provided from the vehicle-mounted device. The vehicle-mounted device includes: a voice collection unit configured to collect in-vehicle conversation; an estimation unit configured to estimate a host-vehicle stop-off facility; a reputation-keyword dictionary having a reputation keyword registered, the reputation keyword expressing a facility reputation; a determination unit configured to determine whether the reputation keyword is included in conversation information collected by the voice collection unit over a certain period of time, associated with the estimated facility; and a transmission unit configured to transmit, based on a result of the determination of the determination unit, the conversation information including the reputation keyword collected over the certain period of time and identification information regarding the estimated facility, to the server. The server includes: an evaluation-information database storing the identification information and the evaluation information regarding a facility in association, the evaluation information including service or merchandise provided by the facility and a phrase expressing an evaluation of the service or merchandise; an evaluation-information generation unit configured to generate, in a case where the conversation information includes the service or merchandise, the evaluation information regarding the service or merchandise of the estimated facility, and in a case where the conversation information does not include the service or merchandise, the evaluation information regarding the estimated facility, based on the reputation keyword; and a registration unit configured to register the evaluation information generated by the evaluation-information generation unit, into the evaluation-information database.

In one aspect, the evaluation-information generation unit supplements a subject to the conversation information including the reputation keyword, and generates, in a case where the supplemented subject agrees with the service or merchandise, the evaluation information regarding the service or merchandise. In one aspect, the evaluation-information generation unit supplements a subject to the conversation information including the reputation keyword, and generates, in a case where no subject is present or in a case where the supplemented subject is a facility name, the evaluation information regarding the facility. In one aspect, the server further includes a provision unit configured to provide recommendation information regarding the facility, in response to a request from the vehicle-mounted device. The provision unit calculates evaluation ranking of the service or merchandise, based on the evaluation-information database, to provide the vehicle-mounted device with the identification information and the evaluation information regarding the facility selected based on the evaluation ranking. In one aspect, the evaluation-information database includes personal identification information associated with the evaluation information. The provision unit calculates calculation frequency of the evaluation information, based on the personal identification information, and selects the facility based on the calculation frequency, to provide the vehicle-mounted device with the identification information and the evaluation information regarding the selected facility.

In one aspect, the transmission unit transmits the conversation information collected by the voice collection unit together with date information regarding the conversation, to the server. The registration unit registers the date information in association with the evaluation information, into the evaluation-information database. In one aspect, the transmission unit transmits the conversation information collected by the voice collection unit together with date information regarding the conversation, to the server. The server further includes a seasonal database prescribing a relationship between a time of year, a region, and a seasonal ingredient. The registration unit collates the date information transmitted from the vehicle-mounted device, positional information regarding the estimated facility, and the evaluation information regarding the service or merchandise of the facility generated by the evaluation-information generation unit, with the seasonal database, to register, in a case where the collation is successful, the identification information regarding the facility in association with the seasonal database. In one aspect, the provision unit retrieves, with reference to the seasonal database, the facility based on the date information and the positional information included in the request from the vehicle-mounted device, to provide the retrieved facility as the recommendation information.

According to an embodiment of the present invention, there is provided a vehicle-mounted device having a function of collecting reputation information regarding a facility and being capable of communicating with a server having a function of generating evaluation information, the vehicle-mounted device including: an estimation unit configured to estimate a host-vehicle stop-off facility; a reputation-keyword dictionary having a reputation keyword registered, the reputation keyword expressing a facility reputation; a voice collection unit configured to collect in-vehicle voice conversation over a certain period of time, associated with the estimated facility of the estimation unit; a determination unit configured to determine whether the reputation keyword is included in conversation information collected by the voice collection unit; and a transmission unit configured to transmit, in a case where the determination unit determines that the reputation keyword is included in the conversation information, the conversation information including the reputation keyword collected over the certain period of time and identification information regarding the estimated facility, to the server.

In one aspect, the reputation-keyword dictionary includes the reputation keyword for each facility genre. The determination unit determines whether the conversation information includes the reputation keyword in a genre agreeing with a genre of the estimated facility.

According to an embodiment of the present invention, the collection of the conversation information over the certain period of time from the stopped-off facility, enables the reputation information regarding the facility to be collected even when no facility name is present in the conversation. The vehicle-mounted device performs primary determination to the conversation information to be evaluated, so that the load of the server can be reduced.

### BRIEF DESCRIPTION OF THE DRAWINGS

FIG. 1 illustrates exemplary in-vehicle conversation content;

FIG. 2 is a diagram of the configuration of an evaluation-information generation system according to an embodiment of the present invention;

FIG. 3 is a diagram of the configuration of a vehicle-mounted device according to the embodiment of the present invention;

FIG. 4 is a diagram of the functional configuration of an evaluation-information collection program according to the embodiment of the present invention;

FIG. 5 is a diagram for describing an acoustic-collection start and an acoustic-collection finish for conversation information according to the embodiment of the present invention;

FIG. 6 is a table for describing a reputation-keyword dictionary group according to the embodiment of the present invention;

FIG. 7 is a flowchart of the operation of transmission determination of the conversation information to a server, according to the embodiment of the present invention;

FIGS. 8A and 8B illustrate the configuration of the server and the functional configuration of an evaluation-information generation program, respectively, according to the embodiment of the present invention;

FIG. 9 is a flowchart for describing the operation of the evaluation-information generation program according to the embodiment of the present invention;

FIG. 10 is a table of an exemplary dictionary for an object to be evaluated according to the embodiment of the present invention;

FIG. 11 is a table of exemplary adoption determination of a conversational sentence after a subject supplement according to the embodiment of the present invention;

FIG. 12 is a table of an exemplary evaluation-information database according to the embodiment of the present invention;

FIG. 13 is a flowchart for describing an operation of providing recommendation information according to the embodiment of the present invention;

FIG. 14 is a table of exemplary facility-evaluation ranking acquired from evaluation information in the evaluation-information database;

FIG. 15 is a table of exemplary ranking of the frequency of appearance of the evaluation information acquired from a personal key in the evaluation-information database;

FIG. 16 is a table of exemplary evaluation-information database according to a second embodiment of the present invention; and

FIG. 17 is a table of exemplary seasonal database according to a third embodiment of the present invention.

### DETAILED DESCRIPTION OF THE PREFERRED EMBODIMENTS

Next, embodiments of the present invention will be described in detail with reference to the drawings. An evaluation-information generation system according to an embodiment of the present invention includes: a vehicle-mounted device having a function of collecting reputation information regarding a facility from in-vehicle conversation content; and a server that generates evaluation information on the basis of information provided from the vehicle-mounted device. In one an aspect, the vehicle-mounted device includes an electronic device, such as a computer mounted in a moving object, such as a vehicle. The electronic device can have a navigation function, an audio-visual reproducing function, and a receiving function for TV broadcasting and radio broadcasting, in addition to the collecting function of the reputation information. The vehicle-mounted device may include a mobile information terminal (e.g., a smartphone or a laptop personal computer).

### Embodiments

Next, an embodiment of the present invention will be described. FIG. 2 is a diagram of the configuration of an evaluation-information generation system according to the embodiment of the present invention. The evaluation-information generation system includes a vehicle-mounted device 100 and a cloud server 200 connected to the vehicle-mounted device 100 through a network NW, such as the Internet. The vehicle-mounted device 100 has a function of collecting reputation information regarding a facility or the like from the conversation content of an in-vehicle passenger. On the other hand, in cooperation with a plurality of vehicle-mounted devices 100, 100-1, and 100-2, the server 200 analyzes, for example, conversation information transmitted from the vehicle-mounted device 100 and generates evaluation information regarding the facility or the like to register the evaluation information into an evaluation-information database. The evaluation-information database can include an analyzed result of, for example, an SNS. When receiving a request for recommendation information from the vehicle-mounted device 100, the server 200 utilizes the evaluation-information database to provide a user with the recommendation information regarding a facility or the like suitable to the preference of the user.

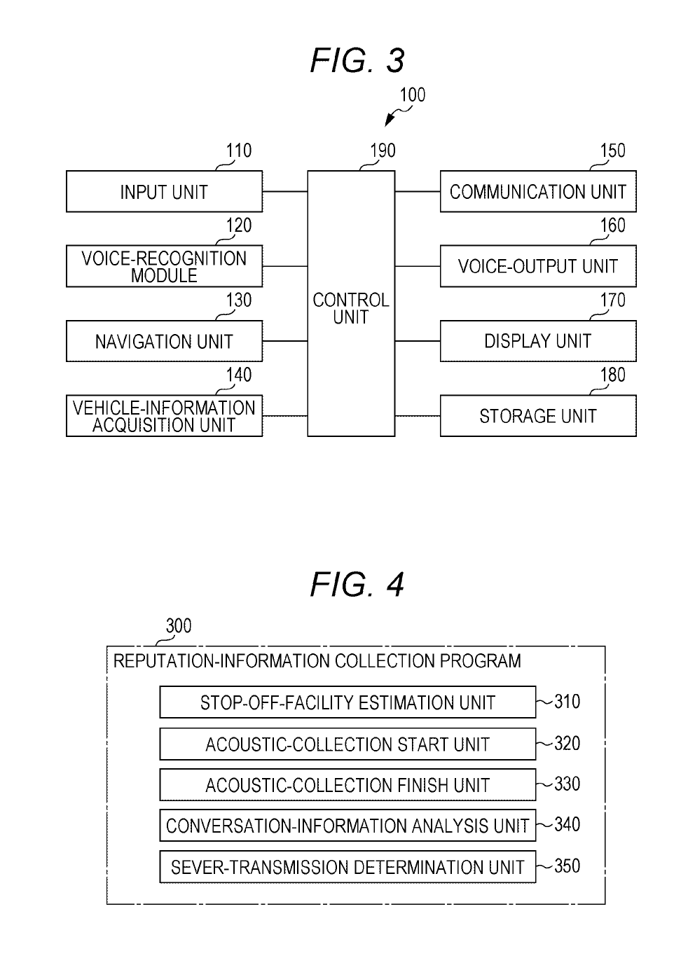

FIG. 3 illustrates the internal configuration of the vehicle-mounted device 100. As illustrated in FIG. 3, the vehicle-mounted device 100 includes: an input unit 110 that receives an instruction from the user; a voice-recognition module 120 to which the conversation voice of the passenger is input, and performs voice recognition to the input voice data; a navigation unit 130 that detects a host-vehicle position on the basis of, for example, a GPS signal transmitted from a GPS satellite or a self-contained navigation sensor, to give road guidance around the detected host-vehicle position or route guidance to a destination; a vehicle-information acquisition unit 140 that acquires vehicle-operation information; a communication unit 150 that allows for data communication outside; a voice output unit 160 that outputs voice; a display unit 170 that displays, for example, a road map based on the navigation unit 130; a storage unit 180 that stores, for example, data and software necessary for the vehicle-mounted device 100; and a control unit 190 that controls each unit. Note that the configuration of the vehicle-mounted device 100 is exemplary, and thus the embodiment is not limited to this. For example, the vehicle-mounted device 100 may include a function of reproducing voice data or video data.

The input unit 110 includes a microphone for inputting voice, in addition to input means, such as a touch panel, a remote controller, and a key. The voice input from the microphone is provided as voice data converted into an electrical signal, to the voice-recognition module 120. The voice-recognition module 120 performs recognition processing to the input voice data, to convert the voice data into, for example, text data.

The navigation unit 130 detects the host-vehicle position on the basis of, for example, the GPS signal and reads map data around the host-vehicle position from the storage unit 180 to display the map data on the display unit 170. When having a destination or a stop-off location set by the user, the navigation unit 130 retrieves a route from the current location or a specified position to, for example, the destination, to give guidance for the retrieved route. Furthermore, when receiving an instruction for retrieval of a facility or the like from the user, the navigation unit 130 retrieves the facility or the like with reference to a map database. As to be described below, when the retrieval of the facility or the like is performed, the navigation unit 130 can acquire the recommendation information regarding the facility or the like from the server 200 and then display the acquired recommendation information on the road map.

The map database used by the navigation unit 130 includes road information (link), junction information (node), and POI information (facility information). The POI information includes names of facilities, locations of the facilities, and genres of the facilities (categories), each facility being given with a POIID (identification). Furthermore, the map database stores a reputation-keyword dictionary group for each POI genre, in association. The details thereof will be described later.

The vehicle-information acquisition unit 140 connected to, for example, an in-vehicle bus, acquires vehicle information (e.g., vehicle-speed pulse information, parking-brake information, and steering information). The communication unit 150 allows for communication, for example, with an external apparatus or an external network through a wireless LAN, a wired LAN, WiFi (registered trademark), Bluetooth (registered trademark), near-field communication, or a public wireless network.

The storage unit 180 stores the data (for example, the map database) and software necessary for the vehicle-mounted device 100. In a preferred aspect, the control unit 190 includes a microcontroller including a ROM and a RAM. The ROM or the RAM stores a program for controlling the operation of the vehicle-mounted device 100. In the present embodiment, the control unit 190 executes a reputation-information collection program serving as part of the evaluation-information generation system. The reputation-information collection program collects the conversation of the in-vehicle passenger, and transmits, if collected conversation information includes the reputation information, the conversation information set with a POIID to the server 200.

FIG. 4 illustrates the functional configuration of the reputation-information collection program 300 according to the present embodiment. The reputation-information collection program 300 includes a stop-off-facility estimation unit 310, an acoustic-collection start unit 320, an acoustic-collection finish unit 330, a conversation-information analysis unit 340, and a server-transmission determination unit 350.

The stop-off-facility estimation unit 310 estimates a stopped-off facility from information regarding a destination or a transit location set by the user in the navigation unit 130 or a vehicle stoppage-time or the host-vehicle position acquired by the vehicle-information acquisition unit 140, to collate the stopped-off facility with the facility information (POI) stored in the map database. For example, as illustrated in FIG. 5, when a host vehicle M having “facility A” set as the destination, stops near the facility A (the vehicle speed is at a certain level or less or the parking brake is on), the stop-off-facility estimation unit 310 extracts, with reference to the map database, a facility near the host-vehicle stopping position to collate the extracted facility with the “facility A”. In a case where the two agree with each other, the stop-off-facility estimation unit 310 determines that the estimation of the “facility A” is correct.

When the stop-off-facility estimation unit 310 estimates the facility, the acoustic-collection start unit 320 starts acoustic collection through the microphone of the input unit 110. In the example of FIG. 5, time Ts at which the estimation of the “facility A” is performed is the start of the acoustic collection. When the acoustic collection starts, voice data output from the microphone is provided to the voice-recognition module 120. Then, the voice-recognition module 120 performs recognition processing on the voice data, to generate text data. The generated text data is accumulated in, for example, a buffer memory in sequence.

When the host-vehicle position is at a certain distance from the estimated stop-off facility, the acoustic-collection finish unit 330 finishes the acoustic collection. That is, the voice input to the microphone stops or the input of the voice data into the voice-recognition module 120 stops. In the example of FIG. 5, the acoustic-collection finish unit 330 finishes the acoustic collection at time Te at which the host-vehicle position is at the certain distance from the “facility A”. In this manner, the conversation information regarding the in-vehicle passenger is being extracted during the certain period of time from time Ts to time Te.

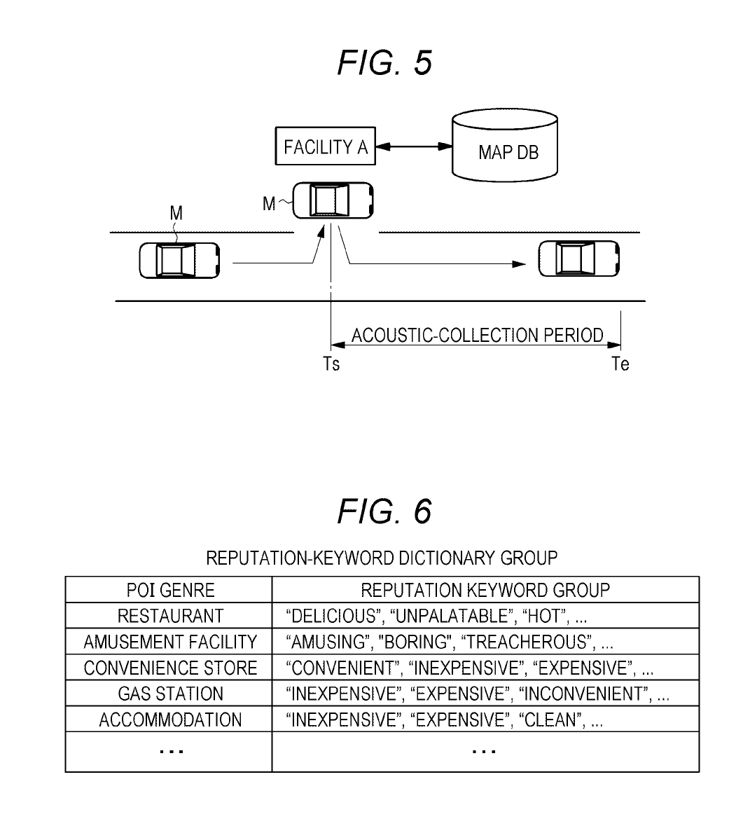

The conversation-information analysis unit 340 analyzes the conversation information acoustically collected between time Ts and time Te (text data), with the reputation-keyword dictionary group. The reputation-keyword dictionary group is prepared in association with the facility information in the map database. The reputation-keyword dictionary group favorably stores a keyword group expressing reputation for each genre of the facilities. For example, the genres of the facilities include restaurant, amusement facility, convenience store, gas station, and accommodation. A keyword group expressing reputation is registered for each of the genres. For example, the reputation for the restaurant is expressed by “delicious”, “unpalatable”, or “hot”. The reputation for the amusement facility is expressed by “amusing”, “boring”, or “treacherous”. The reputation for the convenience store is expressed by “convenient”, “inexpensive”, or “expensive”. FIG. 6 illustrates an exemplary reputation-keyword dictionary group.

The conversation-information analysis unit 340 retrieves the reputation-keyword dictionary group with, as a retrieval operator, a genre corresponding to the genre of the facility estimated by the stop-off-facility estimation unit 310. Then, the conversation-information analysis unit 340 reads a reputation keyword from the reputation-keyword dictionary group and compares the read reputation keyword to the text data that is the conversation information, to analyze whether the conversation information includes the reputation keyword. A result of the analysis is provided to the server-transmission determination unit 350.

The server-transmission determination unit 350 determines whether to transmit the acoustically collected conversation information (text data) to the server 200, on the basis of the result of the analysis of the conversation-information analysis unit 340. That is, in a case where the conversation information includes the reputation keyword, the server-transmission determination unit 350 determines to transmit the conversation information to the server 200. In a case where the conversation information does not include the reputation keyword, the server-transmission determination unit 350 determines not to transmit the conversation information to the server 200. For the latter determination, the conversation information is discarded.

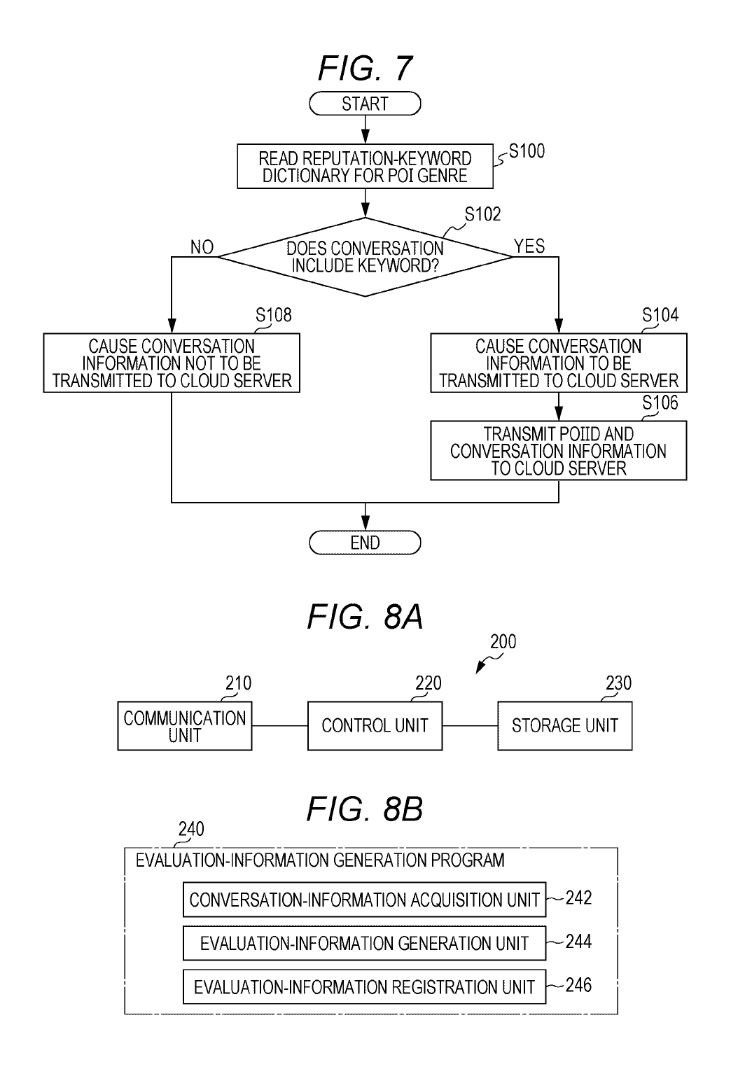

FIG. 7 illustrates a flowchart of the operation of the conversation-information analysis unit 340 and the server-transmission determination unit 350. When the acoustic collection of the conversation of the passenger is finished, the conversation-information analysis unit 340 reads, from the reputation-keyword dictionary group, the reputation keyword for the genre corresponding to the genre of the facility estimated by the stop-off-facility estimation unit 310 (S100). Next, it is determined whether the conversation content includes the reputation keyword (S102). If the conversation content includes the reputation keyword, it is determined that conversation information is to be transmitted to the server 200 (S104), and then the conversation information set with the POIID of the facility is transmitted to the server 200 (S106). On the other hand, if the conversation information does not include the reputation keyword, it is determined that the conversation information is not to be transmitted to the server 200 (S108), and then the conversation information is discarded.

When receiving the conversation information set with the POIID from the vehicle-mounted device 100, the server 200 automatically generates the evaluation information regarding service or merchandise provided by the facility or the evaluation information regarding the facility itself. The server 200 estimates the context of continuous conversation, and supplements, in a case where the conversation includes no subject, the subject, so that the evaluation information regarding the merchandise or service of the facility can be generated.

FIG. 8A illustrates an exemplary configuration of the server 200. The server 200 includes a communication unit 210, a control unit 220, and a storage unit 230. The communication unit 210 allows for communication with the vehicle-mounted device 100 through a network, such as the Internet. The control unit 220 controls the entirety of the evaluation-information generation system, and generates, for example, when receiving the POIID and the conversation information from the vehicle-mounted device 100, the evaluation information regarding the facility or the like. The storage unit 230 stores, for example, data and software necessary for the evaluation-information generation system, and also stores the evaluation-information database in which the evaluation information generated by the control unit 220 is registered.

FIG. 8B is a diagram of the functional configuration of an evaluation-information generation program to be executed by the control unit 220. The evaluation-information generation program 240 includes: a conversation-information acquisition unit 242 that acquires the conversation information and the POIID transmitted from the vehicle-mounted device 100; an evaluation-information generation unit 244 that generates the evaluation information regarding the facility or the like on the basis of the acquired conversation information and POIID; and an evaluation-information registration unit 246 that registers the generated evaluation information into the evaluation-information database.

In a case where the conversation content after the stopping off at the facility includes a reputation keyword expressing reputation but the conversation content does not include the name of the facility, it is highly likely that the talk includes reputation to the facility. The evaluation-information generation unit 244 performs the following determination processing in order to make improvement in precision.

### (1) Subject Supplement

There is a technique of estimating, for continuous conversation, the context thereof to supplement a subject for the conversation. Use of such a technique estimates a subject for a conversation sentence from before-and-after context, to supplement the subject.

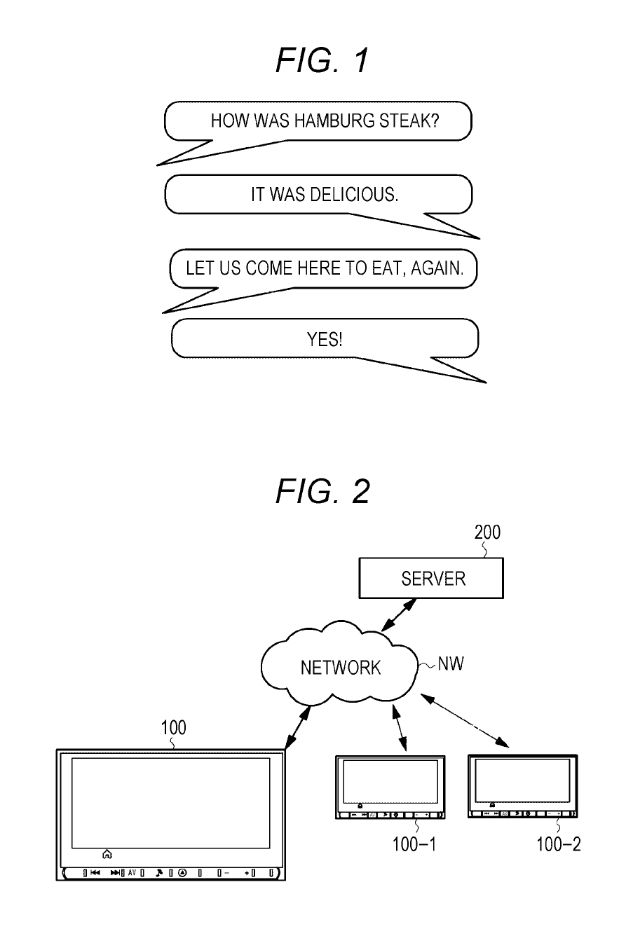

For example, no subject is present in the conversation illustrated in FIG. 1.

When a subject is supplemented in the conversation, the following is acquired. Note that ‘ ’ represents the supplemented subject and underlining represents a reputation keyword.

“How ‘was’ the hamburg steak? ‘The hamburg steak was’ delicious.

Let us come here to have ‘the hamburg steak’, again. Yes.”

### (2) Adoption Determination Based on Tense Determination

In a case where a sentence including a reputation keyword includes past tense or future tense with respect to the current time, the conversation information is not to be evaluated. As an aspect, a dictionary in which tense words for an object not to be evaluated have been registered for each time zone, is prepared. In a case where the conversation information includes a tense word in the dictionary, the conversation information is not to be evaluated. For example, as an exemplary dictionary for a time zone ranging from 11:00 to 15:00, tense words “last year, yesterday, last night, this morning, the other day, tonight, tomorrow, and the like” are prepared. In a case where the conversation content includes a tense word registered in the dictionary with the time of the conversation information acquired from the vehicle-mounted device 100, ranging between 11:00 and 15:00, it is assumed that the reputation keyword does not relate to the stop-off facility, so that the conversation information is not to be evaluated.

### (3) Adoption Determination Based on Dictionary for Object to be Evaluated

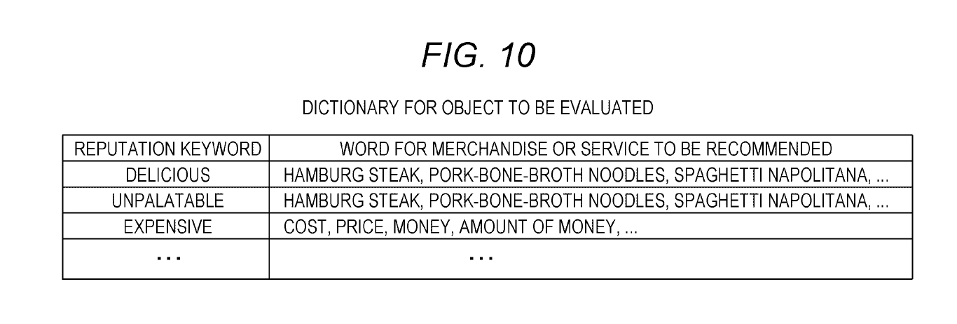

If the supplemented subject to the reputation keyword in the subject-supplement processing in (1) corresponds to the merchandise or service of the facility to be recommended, the conversation information is adopted as effective reputation information. In an aspect, a dictionary for an object to be evaluated is created that prescribes the relationship between each reputation keyword and the merchandise or service of the facility to be recommended. FIG. 10 illustrates an exemplary dictionary for an object to be evaluated. For example, the merchandise or service to be recommended as “delicious” is prescribed with menus such as “hamburg steak”, “pork-bone-broth noodles”, “spaghetti Napolitana”, and “steak”. The merchandise or service to be recommended as “expensive” is prescribed with words such as “cost”, “price”, “money”, and “amount of money”, expressing a price.

### (4) Adoption Determination for Qualified Subject

In a case where the subject in (3) qualified with (of) has been qualified with a word that is not the name of the target facility or tense, the conversation information is not to be evaluated. The name of the target facility is specified with the POIID transmitted together with the conversation information. The tense is not included in the tense dictionary in (2).

For example, the name of the stopped-off facility is defined as ABC gourmet.

Objects to be Evaluated (Qualified with Facility Name or Tense)

A hamburg steak “of” ABC gourmet

A hamburg steak “of” today

A hamburg steak “of” the last time

### Objects not to be Evaluated

A hamburg steak of ∘∘ house

A hamburg steak of ΔΔ

### (5) Determination as Reputation Information Regarding Entire Facility

In a case where no subject is present or the name of the target facility is the subject, the conversation information is to be the evaluation information regarding the entire facility.

The evaluation-information generation unit 244 supplements the subject for the conversation information as described above, to determine whether the conversation information is to be adopted as the evaluation information. On the basis of a result of the determination, the evaluation-information registration unit 246 registers the conversation information determined as the evaluation information, into the evaluation-information database.

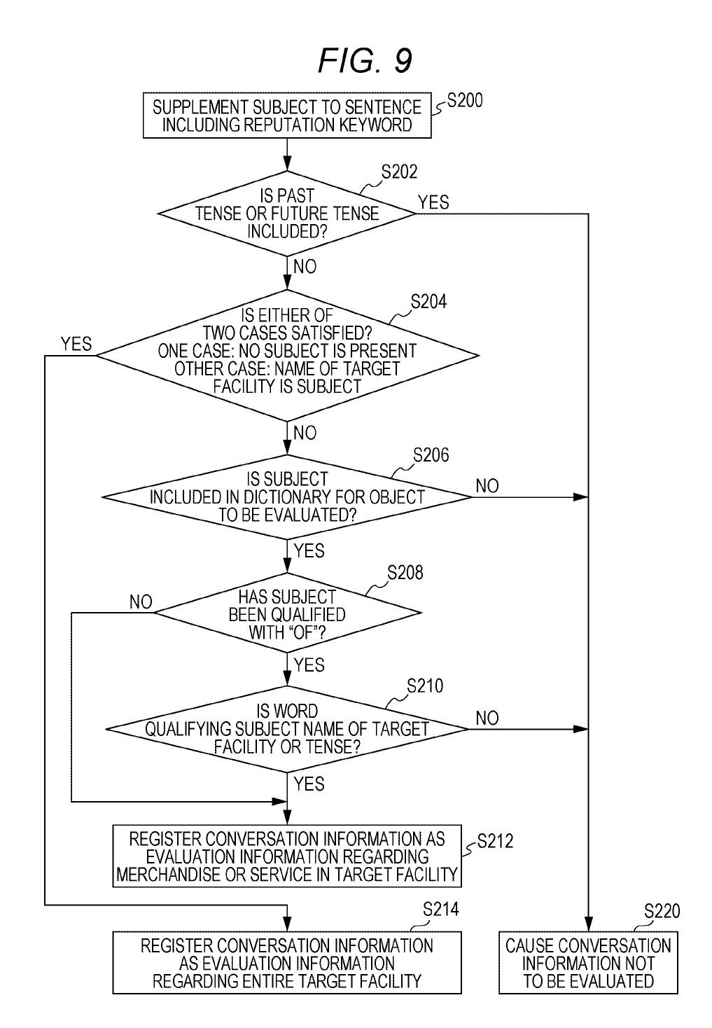

FIG. 9 is a flowchart for describing the operation of the evaluation-information generation program 240. First, the evaluation-information generation unit 244 supplements a subject for the conversation information (text data) including a reputation keyword, acquired from the vehicle-mounted device 100 (S200). It is determined whether a sentence of the conversation supplemented with the subject includes past tense or future tense (S202). If the past tense or the future tense is included, the conversation information is not to be evaluated (S220).

In a case where the sentence does not include the past tense or the future tense, it is determined whether no subject is present or the facility is the subject (S204). If the determination is positive, i.e., no subject is present or the facility is the subject, the reputation keyword is registered as the evaluation information expressing the entire facility (S214). On the other hand, if the determination is negative, it is determined whether the subject is included in the dictionary for an object to be evaluated (S206). In a case where the subject is not included in the dictionary for an object to be evaluated, the conversation information is not to be evaluated (S220). On the other hand, in a case where the subject is included in the dictionary for an object to be evaluated, it is further determined whether the subject has been qualified with “of” (S208). If the subject has not been qualified with “of”, the conversation information is registered as the evaluation information regarding the merchandise or service in the target facility (S212). In a case where the subject has been qualified with “of”, it is further determined whether a word qualifying the subject is the name of the target facility or tense (S210). In a case where the word qualifying the subject is the name of the target facility or tense, the conversation information is registered as the evaluation information regarding the merchandise or service in the target facility (S212). Otherwise, the conversation information is not to be evaluated (S220).

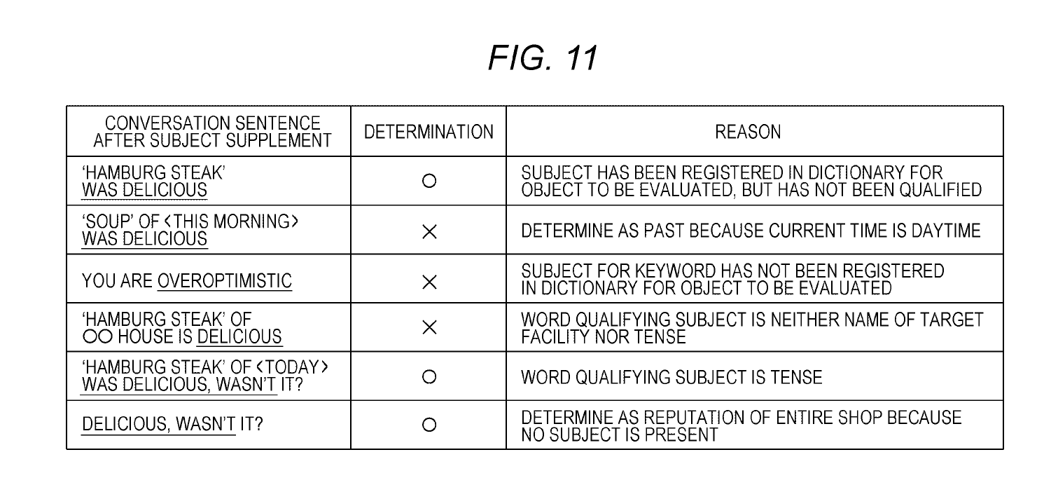

FIG. 11 illustrates exemplary adoption determination for the evaluation information by the evaluation-information generation unit 244.

Underline: a reputation keyword registered in the restaurant genre

‘ ’: a word for “delicious”, included in the dictionary for an object to be evaluated

< >: a word expressing tense

Stopped-off facility: ABC gourmet

Stop-off time: 13:00

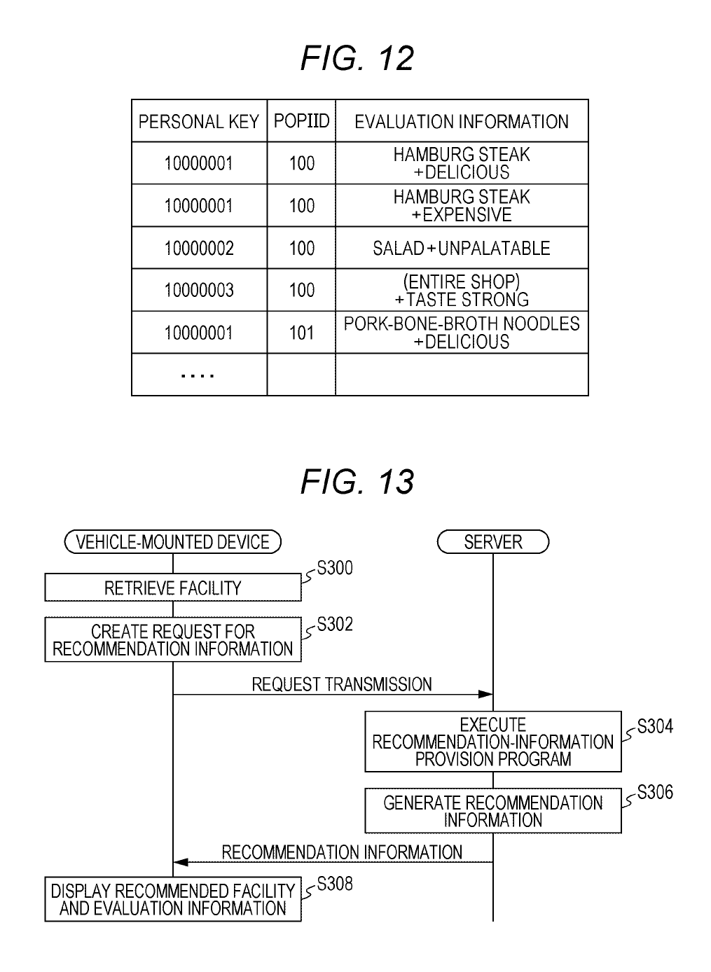

Next, the details of the evaluation-information registration unit 246 will be described. The evaluation-information registration unit 246 registers, into the evaluation-information database, the evaluation information in association with a personal code and a POIID. As described above, in a case where the subject qualifying the reputation keyword corresponds to the merchandise or service provided by the facility, the subject and the reputation keyword are registered as the evaluation information. In a case where no subject is present or the facility is the subject, the reputation keyword is registered as the evaluation information expressing the entire facility. FIG. 12 illustrates an exemplary evaluation-information database. For example, the evaluation information having a POIID of “100” includes “a hamburg steak” is “delicious” and ““a salad” is “unpalatable” as the merchandise or service provided by a restaurant, and the evaluation information regarding the entire restaurant includes “taste strong”. The POIID of the evaluation-information database is a key when the vehicle-mounted device 100 displays a facility as the recommendation information. For example, the evaluation-information database may have the evaluation information registered for each genre so as to perform refining retrieval for each genre.

The control unit 220 of the server 200 further executes a recommendation-information provision program of providing the recommendation information to the user on the basis of the evaluation-information database (refer to FIG. 12). In response to a request from the vehicle-mounted device 100, the recommendation-information provision program retrieves a facility to be recommended, with, as a retrieval key, the personal key or the evaluation information in the evaluation-information database, and provides the vehicle-mounted device 100 with the POIID and the evaluation information regarding the retrieved facility.

FIG. 13 is a flowchart for describing the operation of the evaluation-information generation system when the vehicle-mounted device 100 requests the recommendation information. For example, when the navigation unit 130 performs facility retrieval (S300), the navigation unit 130 creates a request for the recommendation information (S302) and then transmits the request to the server 200. The transmission of the request may be automatically performed or may be determined by an operation of the user. The request can include the preference of the user, and, for example, the user can request “a facility at which meat is delicious”. For example, the preference of the user may be allowed to be selected from a previously prepared preference list.

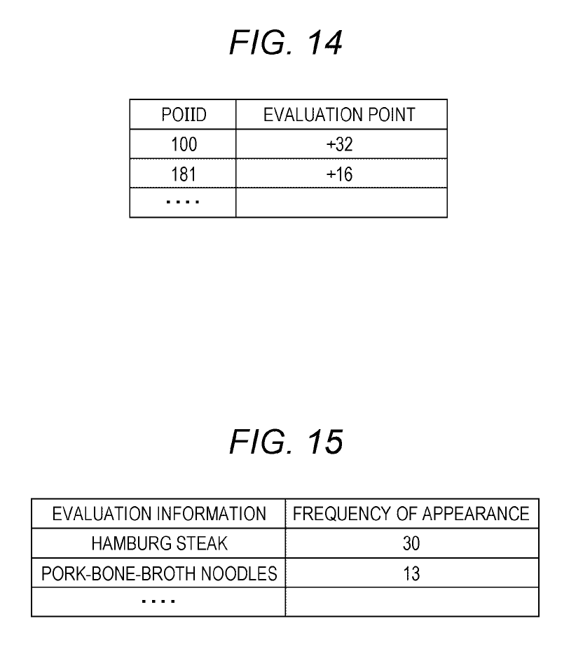

When the server 200 receives the request for the recommendation information, the recommendation-information provision program is executed (S304). In a case where the request from the user includes preference, the recommendation-information provision program analyzes the evaluation information without the personal key in the evaluation-information database, to aggregate the evaluation point of a facility having the evaluation information corresponding to the preference. For example, in a case where the user requests “a facility at which meat is delicious”, the recommendation-information provision program selects the evaluation information associated with “meat” from the evaluation information in the evaluation-information database, to calculate a total for each facility. In this case, when the evaluation information including “meat is delicious” and the evaluation information including “meat is not delicious”, conflicting with each other, are present for the same facility, higher-ratio evaluation information is to be the evaluation information regarding the facility. In this manner, the total of the evaluation “meat is delicious” is an evaluation point, as illustrated in FIG. 14, and evaluation ranking for “a facility at which meat is delicious” is acquired.

The recommendation-information provision program selects a facility having a certain level in the evaluation ranking or a facility having a certain level in the evaluation point, to transmit, as the recommendation information, the POIID and the evaluation information regarding the selected facility to the vehicle-mounted device 100 (S306). When receiving the recommendation information, the navigation unit 130 identifies the facility with, as a key, the POIID included therein, to display the recommended facility onto the road map of the display unit 170 and to display the evaluation information with a balloon, simultaneously (S308). This arrangement can recommend a facility at which meat is delicious, to a user who likes meat.

Meanwhile, in a case where the request from the user includes no preference, the recommendation-information provision program aggregates the evaluation information from the personal key without the POIID. That is, the evaluation information having the personal key corresponding to the user is retrieved from the evaluation-information database, and then the frequency of appearance of the same merchandise or service to be recommended is aggregated in the retrieved evaluation information to acquire the ranking. In an aspect, the voice data of the conversation of the in-vehicle passenger is identified to specify the personal key (in this case, the association between the voice data and the personal key has been previously registered). In another aspect, the user logs in the server 200 to specify the personal key. For example, as illustrated in FIG. 15, in a case where the user's evaluation information includes a large amount of information regarding meat, it can be determined that the user has high preference or interest in meat. In this manner, the recommendation-information provision program determines the preference of the user from the personal key in the evaluation-information database and generates, with a method similar to the above, the recommendation information regarding the facility in which the preference of the user has been reflected, on the basis of a result of the determination, to transmit the recommendation information to the vehicle-mounted device 100.

The evaluation-information generation system according to the present embodiment as described above can learn individual preference from in-vehicle conversation content and extract the reputation of a facility, simultaneously, to fulfill information to be used for recommendation. Furthermore, extraction of the conversation information over a certain period from a stopped-off facility enables the reputation information regarding the facility to be collected even when a word corresponding to the name of the facility is not included during the conversation. In addition, supplement of a subject enables the evaluation information regarding the facility to be precisely automatically generated even in a case where the conversation content does not include the name of the facility.

For each stop-off facility, if the vehicle-mounted device 100 transmits the conversation information to the server 200 and then the server 200 analyzes the conversation information, the load of the server 200 increases. In the present embodiment, however, the vehicle-mounted device 100 has the reputation-keyword dictionary group for each POI genre. The processing of determining whether conversation includes a reputation keyword registered in the reputation-keyword dictionary group is performed on the vehicle-mounted device side, and the conversation data acoustically collected over a certain period is transmitted, only in a case where the reputation keyword is included, to the server 200 for analysis. Thus, the conversation information is subjected to primary determination on the vehicle-mounted device side, so that the load on the server side can be reduced. Furthermore, the evaluation-information database set with the personal key is managed on the server 200, so that the evaluation-information database can be utilized even in a case where a different individual uses a vehicle, such as carsharing.

Next, a second embodiment of the present invention will be described. In the second embodiment, when the conversation of a passenger is acoustically collected, an acoustic-collection start unit 320 and an acoustic-collection finish unit 330 generate date information regarding the conversation (e.g., year, month, day, and time). When transmitting conversation information to a server 200, a server-transmission determination unit 350 transmits the conversation information in association with date information to the server 200.

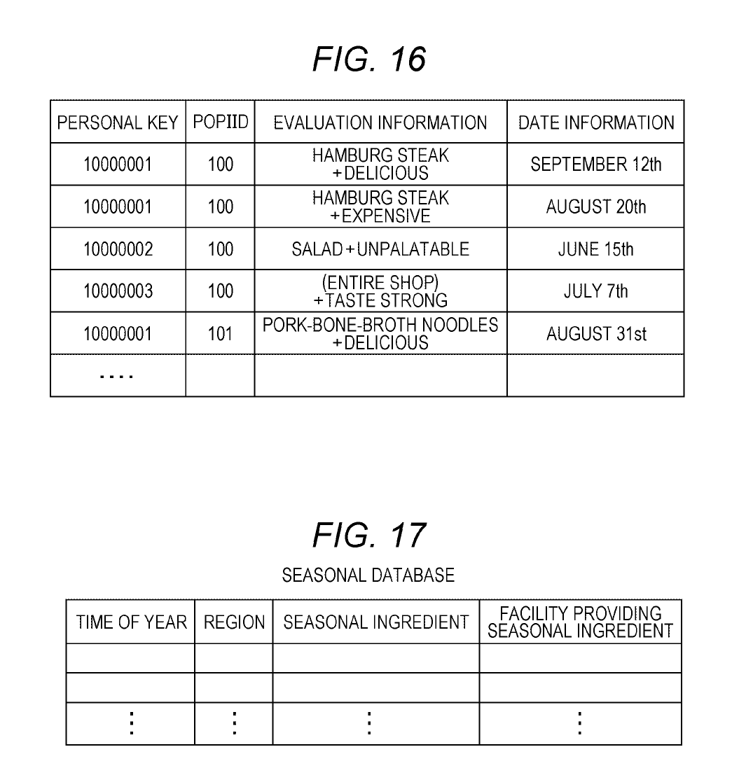

When receiving the conversation information, the server 200 generates evaluation information from the conversation information, similarly to the first embodiment. When registering the evaluation information into an evaluation-information database, for example, an evaluation-information registration unit 246 of the server 200 registers the date information regarding the conversation together, as illustrated in FIG. 16. This arrangement enables the evaluation-information database to include the evaluation information regarding the right season corresponding to a time of year or a season.

For example, a user X eats a seasonal ingredient A at date S at a restaurant R, and the evaluation information (e.g., delicious or seasonal) is registered into the evaluation-information database. In a case where a different user Y retrieves a restaurant (genre) at a time of date S, the evaluation-information database is retrieved with, as a retrieval key, the date information, so that a restaurant having a high evaluation point therefrom is provided as recommendation information to the user Y. If the recommendation information includes the evaluation of the seasonal ingredient A provided by the restaurant R, the user Y can know the evaluation. Alternatively, the user Y can retrieve a restaurant with, as a retrieval key, the seasonal ingredient A, to know a restaurant R providing the seasonal ingredient A and the time thereof.

Next, a third embodiment of the present invention will be described. In the third embodiment, in cooperation with a seasonal database in which time of year, region, and seasonal ingredient have been registered, a facility carrying a seasonal ingredient is registered and then the facility carrying the seasonal ingredient is recommended. A server 200 includes the seasonal database in which time of year, region, and seasonal ingredient have been registered, as illustrated in FIG. 17. The seasonal database may be included in an evaluation-information database, or may cooperate with the evaluation-information database.

When transmitting conversation information regarding a passenger, a vehicle-mounted device 100 transmits date information regarding acoustic-collection of the conversation information and at least one of the POIID of a facility estimated by a stop-off-facility estimation unit 310 and positional information regarding the facility, to the server 200, in addition to the conversation information. An evaluation-information registration unit 246 collates the date of the acoustically collected conversation information, the position of the estimated facility (for the transmission of the POIID, the position of the facility specified from the POIID), and generated evaluation information (a word for merchandise or service to be recommended) with the seasonal database. In a case where the collation is successful, the POIID of the facility is registered as a facility carrying a seasonal ingredient into the seasonal database.

Meanwhile, after the server 200 receives a request for recommendation information from a user of the vehicle-mounted device 100, in a case where a recommendation-information provision program of the server 200 has retrieved, with reference to the seasonal database, a facility agreeing with the month and day and the region (the current position of the vehicle-mounted device 100, a destination, or a stop-off location) included in the request, the facility providing a seasonal ingredient is provided as the recommendation information to the user. Note that the evaluation information regarding the facility may be provided together as the recommendation information. This arrangement enables the user to know the evaluation of the facility providing a seasonal ingredient and service or the like provided by the facility.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. An evaluation-information generation system comprising:
a vehicle-mounted device; and
a server configured to generate evaluation information, based on information provided from the vehicle-mounted device,
wherein the vehicle-mounted device includes:
a voice collection unit configured to collect in-vehicle conversation;
an estimation unit configured to estimate a host-vehicle stop-off facility;
a reputation-keyword dictionary having a reputation keyword registered, the reputation keyword expressing a facility reputation;
a determination unit configured to determine whether the reputation keyword is included in conversation information collected by the voice collection unit over a certain period of time, associated with the estimated facility; and
a transmission unit configured to transmit, based on a result of the determination of the determination unit, the conversation information including the reputation keyword collected over the certain period of time and identification information regarding the estimated facility, to the server, and
the server includes:
an evaluation-information database storing the identification information and the evaluation information regarding a facility in association, the evaluation information including service or merchandise provided by the facility and a phrase expressing an evaluation of the service or merchandise;
an evaluation-information generation unit configured to generate, in a case where the conversation information includes the service or merchandise, the evaluation information regarding the service or merchandise of the estimated facility, and in a case where the conversation information does not include the service or merchandise, the evaluation information regarding the estimated facility, based on the reputation keyword; and
a registration unit configured to register the evaluation information generated by the evaluation-information generation unit, into the evaluation-information database.

2. The evaluation-information generation system according to claim 1, wherein the evaluation-information generation unit supplements a subject to the conversation information including the reputation keyword, and generates, in a case where the supplemented subject agrees with the service or merchandise, the evaluation information regarding the service or merchandise.

3. The evaluation-information generation system according to claim 1, wherein the evaluation-information generation unit supplements a subject to the conversation information including the reputation keyword, and generates, in a case where no subject is present or in a case where the supplemented subject is a facility name, the evaluation information regarding the facility.

4. The evaluation-information generation system according to claim 1, wherein the server further includes a provision unit configured to provide recommendation information regarding the facility, in response to a request from the vehicle-mounted device, and
the provision unit calculates evaluation ranking of the service or merchandise, based on the evaluation-information database, to provide the vehicle-mounted device with the identification information and the evaluation information regarding the facility selected based on the evaluation ranking.

5. The evaluation-information generation system according to claim 4, wherein the evaluation-information database includes personal identification information associated with the evaluation information, and
the provision unit calculates calculation frequency of the evaluation information, based on the personal identification information, and selects the facility based on the calculation frequency, to provide the vehicle-mounted device with the identification information and the evaluation information regarding the selected facility.

6. The evaluation-information generation system according to claim 1, wherein the transmission unit transmits the conversation information collected by the voice collection unit together, with date information regarding the conversation, to the server, and
the registration unit registers the date information in association with the evaluation information, into the evaluation-information database.

7. The evaluation-information generation system according to claim 1, wherein the transmission unit transmits the conversation information collected by the voice collection unit together with date information regarding the conversation, to the server,
the server further includes a seasonal database prescribing a relationship between a time of year, a region, and a seasonal ingredient, and
the registration unit collates the date information transmitted from the vehicle-mounted device, positional information regarding the estimated facility, and the evaluation information regarding the service or merchandise of the facility generated by the evaluation-information generation unit, with the seasonal database, to register, in a case where the collation is successful, the identification information regarding the facility in association with the seasonal database.

8. The evaluation-information generation system according to claim 7, wherein the provision unit retrieves, with reference to the seasonal database, the facility based on the date information and the positional information included in the request from the vehicle-mounted device, to provide the retrieved facility as the recommendation information.

9. A vehicle-mounted device being capable of communicating with a server having a function of generating evaluation information and having a function of collecting reputation information regarding a facility, the vehicle-mounted device comprising:
an estimation unit configured to estimate a host-vehicle stop-off facility;
a reputation-keyword dictionary having a reputation keyword registered, the reputation keyword expressing a facility reputation;
a voice collection unit configured to collect in-vehicle voice conversation over a certain period of time, associated with the estimated facility of the estimation unit;
a determination unit configured to determine whether the reputation keyword is included in conversation information collected by the voice collection unit; and
a transmission unit configured to transmit, in a case where the determination unit determines that the reputation keyword is included in the conversation information, the conversation information including the reputation keyword collected over the certain period of time and identification information regarding the estimated facility, to the server.

10. The vehicle-mounted device according to claim 9, wherein the reputation-keyword dictionary includes the reputation keyword for each facility genre, and
the determination unit determines whether the conversation information includes the reputation keyword in a genre agreeing with a genre of the estimated facility.

11. The vehicle-mounted device according to claim 9, wherein the transmission unit transmits date information regarding the collection of the conversation information, in association with the conversation information, to the server.

12. An evaluation-information generation system for use with a vehicle, comprising:
a voice collection unit configured to collect in-vehicle conversation;
an estimation unit configured to estimate a host-vehicle stop-off facility;
a reputation-keyword dictionary having a reputation keyword registered, the reputation keyword expressing a facility reputation;
a determination unit configured to determine whether the reputation keyword is included in conversation information collected by the voice collection unit over a certain period of time, associated with the estimated facility;
an evaluation-information database storing identification information regarding the estimated facility and evaluation information regarding a facility in association, the evaluation information including service or merchandise provided by the facility and a phrase expressing an evaluation of the service or merchandise;
an evaluation-information generation unit configured to generate, in a case where the conversation information includes the service or merchandise, the evaluation information regarding the service or merchandise of the estimated facility, and in a case where the conversation information does not include the service or merchandise, the evaluation information regarding the estimated facility, based on the reputation keyword; and
a registration unit configured to register the evaluation information generated by the evaluation-information generation unit, into the evaluation-information database.

13. The evaluation-information generation system according to claim 12, wherein the evaluation-information generation unit supplements a subject to the conversation information including the reputation keyword, and generates, in a case where the supplemented subject agrees with the service or merchandise, the evaluation information regarding the service or merchandise.

14. The evaluation-information generation system according to claim 12, wherein the evaluation-information generation unit supplements a subject to the conversation information including the reputation keyword, and generates, in a case where no subject is present or in a case where the supplemented subject is a facility name, the evaluation information regarding the facility.

15. The evaluation-information generation system according to claim 12, further comprising a provision unit configured to provide recommendation information regarding the facility, and the provision unit calculates evaluation ranking of the service or merchandise, based on the evaluation-information database, to provide the identification information and the evaluation information regarding the facility selected based on the evaluation ranking.

16. The evaluation-information generation system according to claim 15, wherein the evaluation-information database includes personal identification information associated with the evaluation information, and the provision unit calculates calculation frequency of the evaluation information, based on the personal identification information, and selects the facility based on the calculation frequency, to provide the identification information and the evaluation information regarding the selected facility.

17. The evaluation-information generation system according to claim 12, wherein the registration unit registers date information in association with the evaluation information, into the evaluation-information database.

18. The evaluation-information generation system according to claim 12, further comprising a seasonal database prescribing a relationship between a time of year, a region, and a seasonal ingredient, and the registration unit collates date information, positional information regarding the estimated facility, and the evaluation information regarding the service or merchandise of the facility generated by the evaluation-information generation unit, with the seasonal database, to register, in a case where the collation is successful, the identification information regarding the facility in association with the seasonal database.

19. The evaluation-information generation system according to claim 18, wherein the provision unit retrieves, with reference to the seasonal database, the facility based on the date information and the positional information, to provide the retrieved facility as the recommendation information.
